(19) United States
(12) Patent Application Publication
(10) Pub. No.: US 2020/0044769 A1
(43) Pub. Date: Feb. 6, 2020

(54) ADAPTIVE BIT RATES FOR WI-FI AND BLUETOOTH COEXISTENCE

(71) Applicant: QUALCOMM Incorporated, San Diego, CA (US)

(72) Inventors: Kiran Neelisetty, San Jose, CA (US); Shashidhar Shenoy, San Jose, CA (US); Pattabiraman Subramanian, Fremont, CA (US)

(21) Appl. No.: 16/054,445

(22) Filed: Aug. 3, 2018

(51) Int. Cl. H04L 1/00; H04W 72/12; H04L 29/06; H04W 4/80

(52) U.S. Cl. CPC H04L 1/0013; H04W 72/1215; H04W 84/12; H04W 4/80; H04L 65/607

(57) ABSTRACT

Methods, systems, and devices for wireless local area network (WLAN) communication (e.g., Wi-Fi) and Bluetooth coexistence are described. A wireless device may consider the WLAN condition (e.g., whether a WLAN operation is critical) and the Bluetooth medium usage (e.g., Bluetooth bandwidth usage) to determine or adjust encoding schemes (e.g., such as Bluetooth codec or bit rate) for Bluetooth communications. In conditions where critical WLAN activity is to be performed (such as WLAN scanning, WLAN connection establishment, etc.) and high bandwidth Bluetooth communications are established, the device may reduce the Bluetooth encoding scheme to a lower profile (e.g., reduce the rate of the encoding scheme). Such may result in a larger window (e.g., increased bandwidth) for the WLAN procedure at the cost of reducing (e.g., temporarily) the Bluetooth quality to a lower codec, rather than risking interference and glitches to Bluetooth communications otherwise configured using higher bandwidth profiles.

### BACKGROUND

The following relates generally to wireless communications, and more specifically to adaptive bit rates for Wi-Fi and Bluetooth coexistence.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between wireless devices. For example, wireless devices such as cellular phones may utilize wireless PAN communications to exchange information.

A device may be capable of both Bluetooth and WLAN communications and these communications may be associated with different communication protocols. In some cases, these communications may share a communication medium. As such, coexistence solutions to enable Bluetooth and WLAN communications (e.g., concurrent communications) by devices equipped with both Bluetooth and WLAN operation may be desired.

### SUMMARY

The described techniques relate to improved methods, systems, devices, or apparatuses that support adaptive bit rates for Wi-Fi and Bluetooth coexistence. Generally, the described techniques provide for high bandwidth (e.g., high definition (HD)) encoding scheme adjustment during WLAN procedures (e.g., critical WLAN functionality procedures or WLAN connection essential procedures), such that high bandwidth Bluetooth communications may be employed to the extent the WLAN connection is not deteriorated.

A device may identify a WLAN procedure (e.g., a WLAN connection essential procedure such as a WLAN scanning procedure, a WLAN authentication and association procedure, a WLAN connection establishment procedure, a WLAN parameter negotiation procedure) to be performed. The device may then determine a bandwidth for a communication (e.g., a first Bluetooth communication) based on identifying the WLAN procedure is to be performed, and identify a rate of a first encoding scheme (e.g., a codec rate, bit rate) associated with the communication (e.g., the first Bluetooth communication). In some cases, the rate of the first encoding scheme may be identified based on the determined bandwidth associated with the communication. The device may select a rate of a second encoding scheme for a second communication (e.g., a second Bluetooth communication). For example, the device may select an encoding scheme associated with a reduced rate (e.g., and reduced medium usage) for subsequent communications (e.g., Bluetooth communications), such as for Bluetooth communications to occur during the identified WLAN procedure to be performed. The device may then perform the WLAN procedure while the second Bluetooth communication is configured using the rate of the second encoding scheme.

In some cases, a WLAN component of the device may identify the WLAN procedure is to be performed (e.g., based on some pattern or predictability associated with WLAN connection essential procedures), and may signal a request for a Bluetooth component of the device to signal the bandwidth associated with the first Bluetooth communication. The Bluetooth component of the device may signal an indication of the bandwidth associated with the first Bluetooth communication to the WLAN component of the device, and the WLAN component of the device may signal a request for the Bluetooth component of the device to reduce the encoding scheme for the second Bluetooth communication.

After the WLAN procedure has been performed, in some cases, a rate of a third encoding scheme for a third communication, such as a Bluetooth communication (e.g., Bluetooth communication occurring after the WLAN procedure has been conducted), may be selected, and the third communication may be performed based on the rate of the third encoding scheme. In some examples, the rate of the third encoding scheme may be the same as the rate of the first encoding scheme. That is, in some examples, after the WLAN procedure has been performed, Bluetooth communications may return to being performed based on the rate of the original encoding scheme (e.g., some high bandwidth or HD encoding scheme).

In some cases, the rate of the encoding scheme used for the communications (e.g., for Bluetooth communications) may be adjusted for WLAN procedures, but not for WLAN communications. For example, when high bandwidth or HD codecs are used for Bluetooth communications, the rate of the encoding scheme used may only be adjusted for WLAN connection essential procedures (e.g., WLAN procedures), but not necessarily for other WLAN communications (e.g., such as WLAN data communications).

A method of wireless communications at a device is described. The method may include identifying a WLAN procedure to be performed, determining a bandwidth for a first Bluetooth communication based on identifying the WLAN procedure to be performed, and identifying a rate of a first encoding scheme associated with the first Bluetooth communication (e.g., based on the determined bandwidth, the rate of the first encoding scheme including a codec rate or a bit rate, or both). The method may further include selecting a rate of a second encoding scheme for a second Bluetooth communication to be performed based on the identified WLAN procedure, the rate of the second encoding scheme being lower than the rate of the first encoding scheme, and performing the WLAN procedure while the second Bluetooth communication is configured using the rate of the second encoding scheme.

An apparatus for wireless communications at a device is described. The apparatus may include a processor, memory in electronic communication with the processor, and instructions stored in the memory. The instructions may be executable by the processor to cause the apparatus to identify a WLAN procedure to be performed, determine a bandwidth for a first Bluetooth communication based on identifying the WLAN procedure to be performed, and identify a rate of a first encoding scheme associated with the first Bluetooth communication based on the determined bandwidth, the rate of the first encoding scheme including a codec rate, or a bit rate, or both. The instructions may be executable by the processor to further cause the apparatus to select a rate of a second encoding scheme for a second Bluetooth communication to be performed based on the identified WLAN procedure, the rate of the second encoding scheme being lower than the rate of the first encoding scheme, and perform the WLAN procedure while the second Bluetooth communication is configured using the rate of the second encoding scheme.

Another apparatus for wireless communications at a device is described. The apparatus may include means for identifying a WLAN procedure to be performed, determining a bandwidth for a first Bluetooth communication based on identifying the WLAN procedure to be performed, and identifying a rate of a first encoding scheme associated with the first Bluetooth communication based on the determined bandwidth, the rate of the first encoding scheme including a codec rate, or a bit rate, or both. The apparatus may further include means for selecting a rate of a second encoding scheme for a second Bluetooth communication to be performed based on the identified WLAN procedure, the rate of the second encoding scheme being lower than the rate of the first encoding scheme, and performing the WLAN procedure while the second Bluetooth communication is configured using the rate of the second encoding scheme.

A non-transitory computer-readable medium storing code for wireless communications at a device is described. The code may include instructions executable by a processor to identify a WLAN procedure to be performed, determine a bandwidth for a first Bluetooth communication based on identifying the WLAN procedure to be performed, identify a rate of a first encoding scheme associated with the first Bluetooth communication based on the determined bandwidth, the rate of the first encoding scheme including a codec rate, or a bit rate, or both, select a rate of a second encoding scheme for a second Bluetooth communication to be performed based on the identified WLAN procedure, the rate of the second encoding scheme being lower than the rate of the first encoding scheme, and perform the WLAN procedure while the second Bluetooth communication is configured using the rate of the second encoding scheme.

Some examples of the method, apparatuses, and non-transitory computer-readable medium described herein may further include operations, features, means, or instructions for identifying that the WLAN procedure may have been performed, selecting a rate of a third encoding scheme for a third Bluetooth communication to be performed based on the identification, the rate of the third encoding scheme being higher than the rate of the second encoding scheme and performing the third Bluetooth communication based on the rate of the third encoding scheme.

In some examples of the method, apparatuses, and non-transitory computer-readable medium described herein, the rate of the third encoding scheme for the third Bluetooth communication includes the rate of the first encoding scheme associated with the first Bluetooth communication. In some examples of the method, apparatuses, and non-transitory computer-readable medium described herein, the WLAN procedure includes a WLAN scanning procedure, a WLAN authentication and association procedure, a WLAN connection establishment procedure, a WLAN parameter negotiation procedure, or some combination thereof.

Some examples of the method, apparatuses, and non-transitory computer-readable medium described herein may further include operations, features, means, or instructions for determining that a throughput value associated with one or more WLAN communications exceeds a threshold, where the rate of the second encoding scheme for the second Bluetooth communication may be selected based on the determination. Some examples of the method, apparatuses, and non-transitory computer-readable medium described herein may further include operations, features, means, or instructions for identifying a WLAN communication to be performed and performing the second Bluetooth communication based on the rate of the first encoding scheme associated with the first Bluetooth communication and the identified WLAN communication.

Some examples of the method, apparatuses, and non-transitory computer-readable medium described herein may further include operations, features, means, or instructions for signaling, using a WLAN component of the device, a request for a Bluetooth component of the device to reduce the encoding scheme associated with the second Bluetooth communication from the rate of the first encoding scheme to the rate of the second encoding scheme. Some examples of the method, apparatuses, and non-transitory computer-readable medium described herein may further include operations, features, means, or instructions for identifying, by the WLAN component of the device, a pattern associated with the WLAN procedure, where the WLAN procedure to be performed may be identified based on the pattern, and where signaling the request for the Bluetooth component of the device to reduce the encoding scheme for the second Bluetooth communication may be based on the pattern.

Some examples of the method, apparatuses, and non-transitory computer-readable medium described herein may further include operations, features, means, or instructions for signaling, using the WLAN component of the device, a request for the Bluetooth component of the device to signal the bandwidth for the first Bluetooth communication, receiving, using the WLAN component of the device, an indication of the bandwidth for the first Bluetooth communication based on the request, where the bandwidth for the first Bluetooth communication may be determined based on the indication and signaling, using the WLAN component of the device, the request for the Bluetooth component of the device to reduce the encoding scheme for the second Bluetooth communication based on the indication of the bandwidth for the first Bluetooth communication.

Some examples of the method, apparatuses, and non-transitory computer-readable medium described herein may further include operations, features, means, or instructions for comparing the determined bandwidth for the first Bluetooth communication to a threshold, where selecting the rate of the second encoding scheme for the second Bluetooth communication may be based on the comparison. In some examples of the method, apparatuses, and non-transitory computer-readable medium described herein, selecting the rate of the second encoding scheme for the second Bluetooth communication may include operations, features, means, or instructions for selecting a reduced bit rate for a first link associated with the first and second Bluetooth communication or selecting a reduced codec for the first link associated with the first and second Bluetooth communication.

Some examples of the method, apparatuses, and non-transitory computer-readable medium described herein may further include operations, features, means, or instructions for determining a bandwidth associated with at least one other Bluetooth communication, where identifying the rate of the first encoding scheme associated with the first Bluetooth communication may be based on the determined bandwidth for the first Bluetooth communication and the determined bandwidth associated with the at least one other Bluetooth communication.

### BRIEF DESCRIPTION OF THE DRAWINGS

FIG. 1 illustrates an example of a system for wireless communications that supports adaptive bit rates for Wi-Fi and Bluetooth coexistence in accordance with aspects of the present disclosure.

FIGS. 2 through 4 illustrate examples of timing diagrams that support adaptive bit rates for Wi-Fi and Bluetooth coexistence in accordance with aspects of the present disclosure.

FIG. 5 illustrates example device hardware that supports adaptive bit rates for Wi-Fi and Bluetooth coexistence in accordance with aspects of the present disclosure.

FIG. 6 illustrates an example of a process flow that supports adaptive bit rates for Wi-Fi and Bluetooth coexistence in accordance with aspects of the present disclosure.

FIG. 7 shows a block diagram of a device that support adaptive bit rates for Wi-Fi and Bluetooth coexistence in accordance with aspects of the present disclosure.

FIG. 8 shows a diagram of a system including a device that supports adaptive bit rates for Wi-Fi and Bluetooth coexistence in accordance with aspects of the present disclosure.

FIGS. 9 through 11 show flowcharts illustrating methods that support adaptive bit rates for Wi-Fi and Bluetooth coexistence in accordance with aspects of the present disclosure.

### DETAILED DESCRIPTION

A device may be capable of Bluetooth and wireless local area network (WLAN) communications. For example, WLAN and Bluetooth components may be co-located within a device, such that the device may be capable of communicating according to both Bluetooth and WLAN communication protocols, as each technology may offer different benefits or may improve user experience in different conditions. In some cases, Bluetooth and WLAN communications may share a same medium, such as the same unlicensed frequency medium, which in some cases may result in interference between communications.

For example, when a device is transmitting on Bluetooth while receiving on WLAN, the received WLAN signal may be de-sensed due to self-interference caused by the close proximity of the Bluetooth transmitter. In the case where the device is transmitting on WLAN while receiving on Bluetooth, similar interference problems may occur. As the medium usage (e.g., bandwidth) for Bluetooth communications increases (e.g., arising from increasing demand for higher bandwidth encoding schemes to support high definition (HD) Bluetooth audio), such challenges in dealing with interference may be intensified.

Some coexistence solutions for mitigating interference between Bluetooth and WLAN communications may prioritize certain traffic types (e.g., Bluetooth traffic or WLAN traffic may be prioritized) or coordinate (e.g., in time) Bluetooth and WLAN communications. However, such interference coordination may pose other challenges. For example, for high quality Bluetooth audio applications, Bluetooth traffic may be prioritized over WLAN traffic (e.g., Wi-Fi traffic) to ensure delay sensitive traffic is delivered effectively. But such prioritization may adversely affect WLAN operability, as such prioritization of Bluetooth traffic may, in some cases, inhibit the device from achieving basic WLAN functionality, such as establishing or maintaining WLAN connections. Conversely, prioritizing WLAN traffic and interrupting Bluetooth communications may result in poor Bluetooth performance (e.g., such as interruptions or audio glitches to HD Bluetooth audio).

The described techniques provide for high bandwidth (e.g., HD) encoding scheme adjustment during WLAN procedures (e.g., critical WLAN functionality procedures or WLAN connection essential procedures), such that high bandwidth Bluetooth communications may be employed to the extent the WLAN connection is not deteriorated. During the WLAN procedure (e.g., the WLAN connection essential procedure) the device may temporarily reduce the rate of an encoding scheme (e.g., reduce the Bluetooth codec or Bluetooth bit rate) for Bluetooth communications such that the Bluetooth audio quality is temporarily reduced, rather than risking potential glitches to the HD Bluetooth and/or WLAN procedure failures. Beneficially, these techniques may provide for efficient utilization of high bandwidth Bluetooth audio codecs for HD Bluetooth audio without compromising WLAN connections (e.g., as the WLAN connection essential procedures may be prioritized over the HD Bluetooth audio via temporary encoding scheme adjustments).

For example, a device may consider the WLAN condition (e.g., whether a WLAN operation is critical) and the Bluetooth medium usage (e.g., Bluetooth bandwidth usage) to determine or adjust encoding schemes (e.g., the rate of an encoding scheme, such as Bluetooth codec or bit rate) for Bluetooth communications. In cases where critical WLAN activity is to be performed (such as WLAN scanning, WLAN connection establishment, etc.), the device may reduce the Bluetooth encoding scheme to a lower profile, which may increase the acceptable latency threshold of Bluetooth communications and reduce the Bluetooth medium usage. Such may result in a larger window (e.g., increased bandwidth) for the WLAN procedure at the cost of reducing (e.g., temporarily) the Bluetooth quality to a lower codec. The reducing the rate of the encoding scheme for Bluetooth communications during WLAN procedures may temporarily reduce the quality of the Bluetooth audio, rather than risking interference and glitches to Bluetooth communications otherwise configured using the higher bandwidth profiles.

A WLAN component of a device may identify that a WLAN procedure is to be performed (e.g., based on some pattern or predictability associated with WLAN connection essential procedures), and may signal a request for a Bluetooth component of the device to signal the bandwidth associated with the first Bluetooth communication. The Bluetooth component of the device may signal an indication of the bandwidth associated with the first Bluetooth communication to the WLAN component of the device, and the WLAN component of the device may signal a request for the Bluetooth component of the device to reduce the encoding scheme for the second Bluetooth communication.

In some cases, after the WLAN procedure has been performed, a rate of the encoding scheme for a subsequent Bluetooth communication (e.g., Bluetooth communication occurring after the WLAN procedure has been conducted) may again be adjusted. In some examples, the rate of the encoding scheme for subsequent Bluetooth communications may be the same as the rate of the encoding scheme used for Bluetooth communications prior to the identification of the WLAN procedure. That is, in some examples, after the WLAN procedure has been performed, the device may return to performing Bluetooth communications based on the rate of the original encoding scheme (e.g., some high bandwidth or HD encoding scheme).

Aspects of the disclosure are initially described in the context of a wireless communications system. Example device hardware and process flows for implementing the discussed techniques are then described. Aspects of the disclosure are further illustrated by and described with reference to apparatus diagrams, system diagrams, and flowcharts that relate to adaptive bit rates for Wi-Fi and Bluetooth coexistence

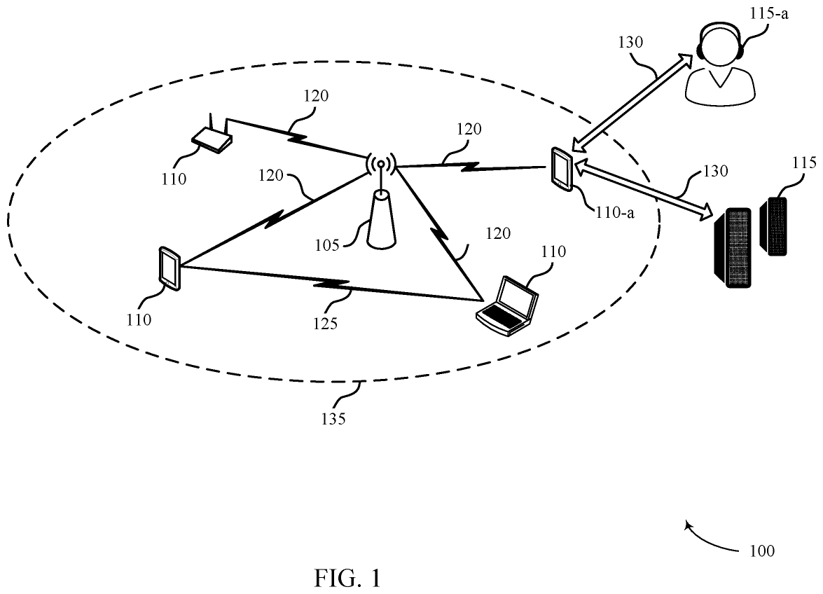

FIG. 1 illustrates a system 100 (e.g., which may include to refer to or include a wireless personal area network (PAN), a wireless local area network (WLAN), a Wi-Fi network) configured in accordance with various aspects of the present disclosure. The system 100 may include an AP 105, devices 110, and paired devices 115 implementing WLAN communications (e.g., Wi-Fi communications) and/or Bluetooth communications. For example, some devices 110 may be capable of both Bluetooth and WLAN communications (e.g., WLAN and Bluetooth components may be co-located within a device 110, such that the device 110 may be capable of both Bluetooth communication and Wi-Fi communication).

A device 110 may support WLAN communications via AP 105 (e.g., over communication links 120). The AP 105 and the associated devices 110 may represent a basic service set (BSS) or an extended service set (ESS). The various devices 110 in the network may be able to communicate with one another through the AP 105. Also shown is a coverage area 135 of the AP 105, which may represent a basic service area (BSA). Further, the device 110 may support Bluetooth communications with one or more paired devices 115 (e.g., over communication links 130). For example, devices 110 may include cell phones, mobile stations, personal digital assistant (PDAs), other handheld devices, netbooks, notebook computers, tablet computers, laptops, or some other suitable terminology. Paired devices 115 may include Bluetooth devices capable of pairing with other Bluetooth devices (e.g., such as devices 110), which may include wireless headsets, speakers, ear pieces, headphones, display devices (e.g., TVs, computer monitors), microphones, meters, valves, etc. Two devices 110 may also communicate directly via a direct wireless link 125 regardless.

Devices 110 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within system 100. AP 105 may be coupled to a network, such as the Internet, and may enable a device 110 to communicate via the network (or communicate with other devices 110 coupled to the AP 105). A device 110 may communicate with a network device bi-directionally. For example, in a WLAN, a device 110 may communicate with an associated AP 105 via downlink (e.g., the communication link from the AP 105 to the device 110) and uplink (e.g., the communication link from the device 110 to the AP 105).

Bluetooth communications may refer to a short-range communication protocol and may be used to connect and exchange information between devices 110 and paired devices 115 (e.g., between mobile phones, computers, digital cameras, wireless headsets, speakers, keyboards, mice or other input peripherals, and similar devices). Bluetooth allows for the creation of a wireless PAN between a master device and one or more slaves devices. In some cases, a device 110 may general refer to a master device, and a paired device 115 may refer to a slave device in a PAN. As such, in some cases, a device may be referred to as either a device 110 or a paired device 115 based on the configuration of the Bluetooth configuration between the device and a second device. That is, designation of a device as either a device 110 or a paired device 115 may not necessarily indicate a distinction in device capability, but rather may refer to or indicate roles held by the device in the PAN. Generally, device 110 may refer to a wireless communication device capable of wirelessly exchanging data signals with another device, and paired device 115 may refer to a device operating in a slave role, or to a short-range wireless device capable of exchanging data signals with the mobile device (e.g., using Bluetooth communication protocols).

In some cases, Bluetooth systems may be organized using a master-slave relationship employing a time division duplex protocol having, for example, defined time slots of 625 mu secs, in which transmission alternates between the master (e.g., device 110) and slave (e.g., paired device 115). In some cases, certain types of Bluetooth communications (e.g., such as high quality or high definition (HD) Bluetooth) may require enhanced quality of service. For example, in some cases, Bluetooth traffic may have higher priority than WLAN traffic and may be delay-sensitive. In some cases, Bluetooth device may be compatible with certain Bluetooth profiles to use desired services. A Bluetooth profile may refer to a specification regarding an aspect of Bluetooth-based wireless communications between devices. For example, a Bluetooth connection may be an extended synchronous connection orientated (eSCO) link for voice call (e.g., which may allow for retransmission), an asynchronous connection-less (ACL) link for music streaming (e.g., A2DP), etc. In some cases, different Bluetooth profiles may be associated with different bandwidth usage, different acceptable latency thresholds, etc.

For example, eSCO packets may be transmitted in predetermined time slots (e.g., 6 Bluetooth slots each for eSCO). The regular interval between the eSCO packets may be specified when the Bluetooth link is established. The eSCO packets to/from a specific slave device (e.g., paired device 115-a) are acknowledged, and may be retransmitted if not acknowledged during a retransmission window. In addition, audio may be streamed between the device 110-a and paired device 115-a using an ACL link (A2DP profile). In some cases, the ACL link may occupy 1, 3, or 5 Bluetooth slots for data or voice. Other Bluetooth profiles supported by Bluetooth devices may include Bluetooth Low Energy (BLE) (e.g., providing considerably reduced power consumption and cost while maintaining a similar communication range), human interface device profile (HID) (e.g., providing low latency links with low power requirements), etc.

With wireless Bluetooth devices, such as headphones, becoming more predominant, improved high fidelity audio playback on Bluetooth headphones (e.g., such as paired devices 115) becomes of higher demand. To support high quality Bluetooth communications, it may be desirable to employ high bandwidth profiles supporting high Bluetooth codecs/bit rates for Bluetooth transmissions (e.g., high quality Bluetooth audio may demand high bandwidth/bit rates).

A device 110 may consider the WLAN condition (e.g., whether a WLAN operation is critical) and the Bluetooth medium usage (e.g., Bluetooth bandwidth usage) to determine or adjust encoding schemes (e.g., the rate of an encoding scheme, such as Bluetooth codec or bit rate) for Bluetooth communications. In conditions where critical WLAN activity is to be performed (such as WLAN scanning, WLAN connection establishment, etc.) the device 110 may reduce the Bluetooth encoding scheme to a lower profile, which may increase the acceptable latency threshold of Bluetooth communications and reduce the Bluetooth medium usage. Such may result in a larger window (e.g., increased bandwidth) for the WLAN procedure at the cost of reducing (e.g., temporarily) the Bluetooth quality to a lower codec, rather than risking interference and glitches to Bluetooth communications otherwise configured using higher bandwidth profiles.

For example, HD codecs (e.g., such as LDAC/APTX-HD at data rates such as 2DH5) may be associated with high bandwidth usage that may account for a significant portion of the bandwidth available to a device for Bluetooth and WLAN operation. Adaptive bit rate algorithms may reduce the rate of the encoding scheme to an encoding scheme associated with less bandwidth during critical WLAN activity (e.g., during WLAN procedures). For example, adaptive bit rate algorithms may reduce an A2DP bit rate or codec to a lower bandwidth codec temporarily during a WLAN scanning, WLAN connection establishment, WLAN authentication and association, WLAN parameter negotiation procedure, WLAN beacon miss, etc. Approximate medium usage of different Bluetooth audio codecs is shown in example Table 1.

TABLE 1

| | 2DH5 | 3DH5 |
|---|---|---|
| | 667 bytes in | 1015 bytes in |
| | 6 slots | 6 slots |
| LDAC 990 OTA BW at 0 RETX | 70% | 45% |
| LDAC 660/ATPX HD OTA | 46% | 30% |
| BW at 0 RETX | | |
| SBC/LDAC330/APTX OTA | <40% | <40% |
| BW at 0 RETX | | |

For example, for a LDAC 990 codec using a 2DH5 data rate, the over the air (OTA) bandwidth (BW) a 0 retransmissions (RETX) may use 70% of the available bandwidth. Practically, other factors may further increase the bandwidth usage by Bluetooth communications. For example, retransmission of audio (e.g., A2DP) packets, Bluetooth non-link activities (e.g., such as inquiry scans, page scans, Bluetooth low energy (BLE)), and other Bluetooth multi-profile activities that may happen along with A2DP (e.g., like object push profile (OPP)/BLE/human interface device (HID)) may increase medium usage of Bluetooth communications.

Reducing the data rate of the LDAC 990 codec to 3DH5 may result in the bandwidth usage dropping to 45%. Reducing the codec from LDAC 990 to LDAC 660 may also reduce the bandwidth usage. As discussed herein, reducing the rate of the encoding scheme may refer to reducing the data rate (e.g., bit rate) of a codec used for Bluetooth communication, reducing the codec used for Bluetooth communication, or both. For example, reducing the codec may refer to configuring subsequent Bluetooth communications with a codec associated with less bandwidth occupation (e.g., less medium usage).

The algorithm may take into account the Bluetooth bandwidth usage (e.g., by product of A2DP codec/bit rate/PER) as well as the Wi-Fi condition (e.g., whether or not a WLAN operation is connection critical). For example, a WLAN procedure discussed herein may refer to a WLAN operation that is connection critical, such as a WLAN scanning procedure, WLAN connection establishment procedure, WLAN authentication and association procedure, WLAN parameter negotiation procedure, WLAN beacon miss, etc. In some cases, the WLAN procedure may be identified based on an identified pattern associated with the WLAN procedure.

For example, device 110-a may identify a pattern, periodicity, schedule, etc. associated with certain WLAN procedures, and may then identify WLAN procedures based on the pattern, periodicity, schedule, etc. In some cases, a WLAN procedure may be identified based on a determination that the WLAN connection is deteriorating (e.g., a WLAN procedure may be identified to be performed in order to maintain the WLAN connection). Once a WLAN procedure is identified, the device 110-a (e.g., the algorithm) may identify bandwidth usage associated with Bluetooth communications and, in cases where Bluetooth communications are utilizing high bandwidth or HD codecs, reduce the rate of the encoding scheme associated with the Bluetooth communications.

For example, a device 110-a may configure Bluetooth communications using a LDAC 990 codec at a data rate of 2DH5 (e.g., which may be associated with approximately 70% of the medium used by the device for WLAN and Bluetooth communications). Device 110-a may identify a WLAN procedure to be performed (e.g., device 110-a may identify a WLAN scanning procedure associated with the AP 105). The device 110-a may determine the bandwidth usage associated with the Bluetooth communication (e.g., determine the Bluetooth communications are associated with 70% medium usage), and may determine to reduce the rate of the encoding scheme associated with the Bluetooth communications while the device 110-a performs the WLAN procedure.

For example, device 110-a may configure subsequent Bluetooth communications (e.g., Bluetooth communications to occur when the device 110-a will perform the WLAN procedure) with a reduced codec (e.g., such as LDAC 660/APTX, SBC/LDAC330/APTX), with a reduced bit rate (e.g., such as 3dH5), or both. These adaptive bit rate techniques may force Bluetooth to use lower bit rate codecs to protect critical WLAN procedures. Further, reducing the rate of the encoding scheme for Bluetooth may temporarily reduce quality during WLAN procedures, but may reduce the occurrence of audio glitches and audio interruptions otherwise associated with concurrent operation of WLAN and HD Bluetooth.

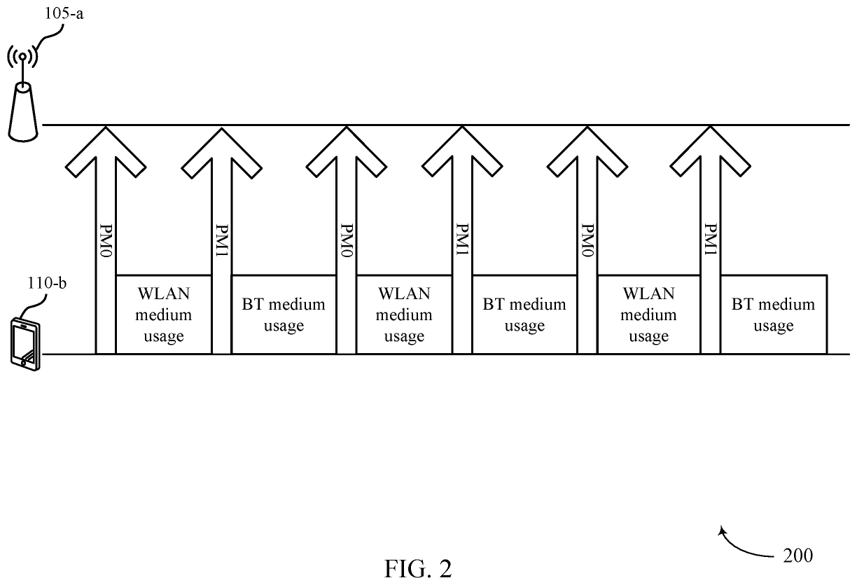

FIG. 2 illustrates an example of a timing diagram 200 that supports adaptive bit rates for Wi-Fi and Bluetooth coexistence in accordance with aspects of the present disclosure. In some examples, timing diagram 200 may implement aspects related to system 100. Timing diagram 200 includes AP 105-a and device 110-b, which may be examples of an AP 105 and device 110 as described with reference to FIG. 1. Timing diagram 200 may illustrate a time sharing approach for low Bluetooth bandwidth usage conditions. For example, device 110-b may send power mode (PM) messages or frames to AP 105-a for Bluetooth and WLAN coexistence. For example, coordination of BT/WLAN for avoiding interference in the power domain may include power back-off or de-boosting.

In some cases, AP 105-a may adjust (e.g., boost) its transmit power and/or use higher modulation to finish transmitting the packets in a given time in order to avoid Bluetooth transmissions, or may avoid transmitting in the duration of Bluetooth transmissions (e.g., for non-critical WLAN operations). In some cases, device 110-b may enter a WLAN power-save mode by sending a Null frame to AP 105-a with the Power Management bit set during Bluetooth communications. The device 110-b may disable or power off some or all components corresponding to WLAN (e.g., WLAN transceiver and RF front end), to minimize interference for Bluetooth communications.

Timing diagram 200 may illustrate a device 110-b utilizing low bandwidth encoding schemes for Bluetooth communications. As such, WLAN communications and Bluetooth communications may share the communications medium and both technologies may function with minimum negative impact. For example, as Bluetooth communications may be associated with relatively low bandwidth usage (e.g., <50%), WLAN procedures may be performed effectively (e.g., without detrimental interference) without adversely affecting Bluetooth communications (e.g., without interrupting or pausing Bluetooth communications), as the remaining bandwidth unoccupied by Bluetooth may suffice for performing such WLAN procedures. In these scenarios (e.g., where Bluetooth bandwidth usage is below some threshold), device 110-b may not need to adjust the rate of the encoding scheme for Bluetooth communication upon identifying that a WLAN procedure is to be performed. In some cases (e.g., when no WLAN procedure is identified or pending), the device 110-b may increase the rate of the encoding scheme, such that the Bluetooth communications may be configured using a higher rate encoding scheme during WLAN inactivity.

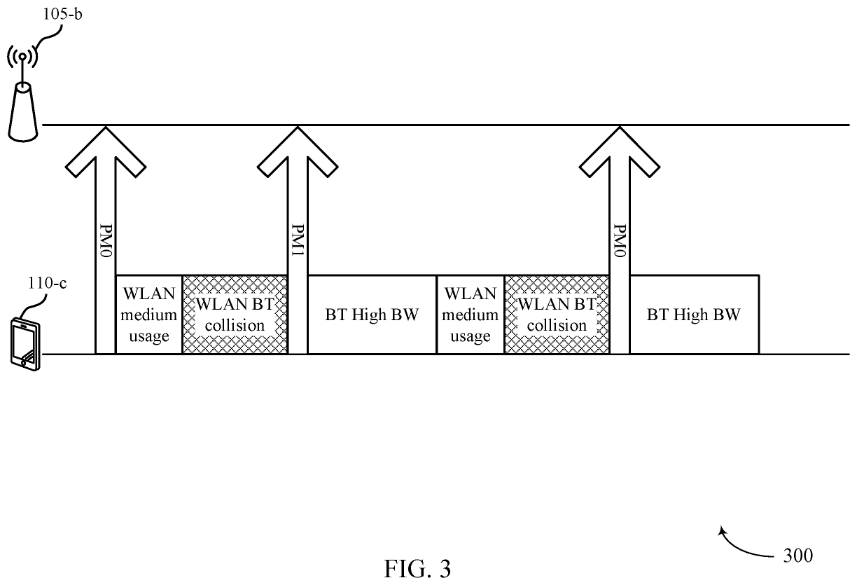

FIG. 3 illustrates an example of a timing diagram 300 that supports adaptive bit rates for Wi-Fi and Bluetooth coexistence in accordance with aspects of the present disclosure. In some examples, timing diagram 300 may implement aspects related to system 100. Timing diagram 300 includes AP 105-b and device 110-c, which may be examples of an AP 105 and device 110 as described with reference to FIG. 1. Timing diagram 300 may illustrate a time sharing approach for high Bluetooth bandwidth usage conditions. In such cases, WLAN Bluetooth collisions may occur, as discussed in more detail herein.

For example, due to the high bandwidth usage by Bluetooth communications and close proximity of the Bluetooth and WLAN transmitter, collisions may more readily occur. As such, the techniques described herein may be implemented to reduce the bandwidth usage by Bluetooth during WLAN procedures. For other WLAN conditions (e.g., during durations of no WLAN activity or during regular WLAN traffic), device 110-c may implement techniques described herein to prioritize Bluetooth traffic or otherwise have WLAN communications avoid Bluetooth communications.

Timing diagram 300 may illustrate a device 110-c utilizing high bandwidth encoding schemes for Bluetooth communications. As such, WLAN communications and Bluetooth communications may share the communications medium and, in some cases, may interfere or collide with each other. For example, as Bluetooth communications may be associated with relatively high bandwidth usage (e.g., >50%), WLAN procedures may be performed ineffectively (e.g., in some cases WLAN procedures may be unsuccessful due to Bluetooth interference) and/or Bluetooth communications may be adversely affected (e.g., Bluetooth communications may be interrupted or experience audio glitches), as the medium utilized to perform WLAN procedures may overlap or conflict with Bluetooth operation. In these scenarios (e.g., where WLAN Bluetooth collisions occur), device 110-c may adjust the rate of the encoding scheme for Bluetooth communication upon identifying that a WLAN procedure is to be performed, according to the techniques described herein.

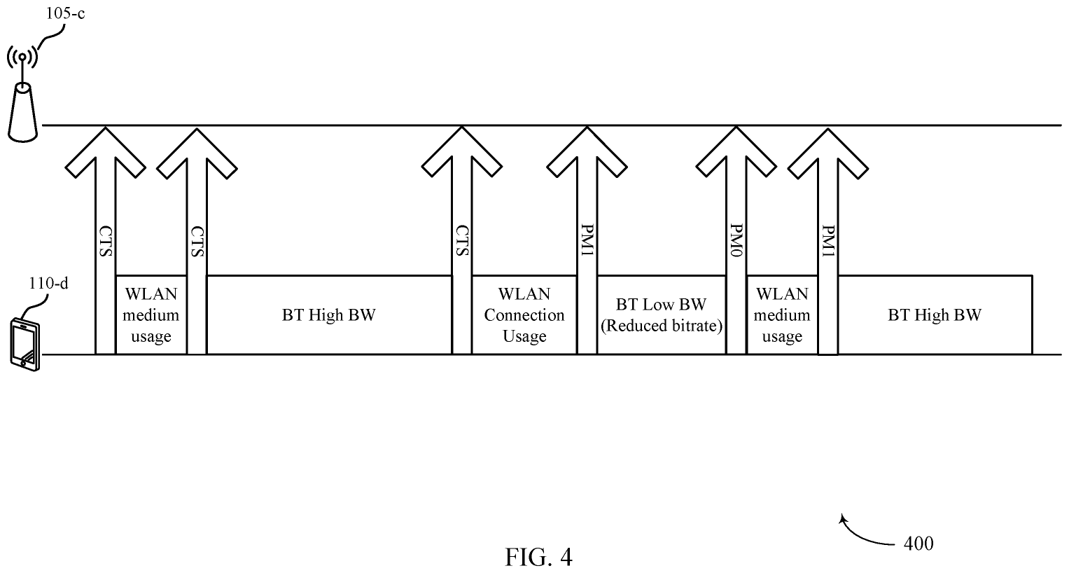

FIG. 4 illustrates an example of a timing diagram 400 that supports adaptive bit rates for Wi-Fi and Bluetooth coexistence in accordance with aspects of the present disclosure. In some examples, timing diagram 400 may implement aspects related to system 100. Timing diagram 400 includes AP 105-c and device 110-d, which may be examples of an AP 105 and device 110 as described with reference to FIG. 1. Timing diagram 400 may illustrate a time sharing approach for high Bluetooth bandwidth usage conditions, where the adaptive bit rate techniques described herein are employed.

For example, Bluetooth communications may utilize high bandwidth codecs (e.g., HD codecs). Once a WLAN procedure is identified, the Bluetooth communications may be configured with a low bandwidth profile (e.g., a reduced bit rate). Following the WLAN procedure, the Bluetooth communications may resume with high bandwidth codecs (e.g., HD codecs).

Timing diagram 400 may illustrate a device 110-d utilizing high bandwidth encoding schemes for Bluetooth communications. As such, device 110-d may adjust the rate of the encoding scheme for Bluetooth communication upon identifying that a WLAN procedure is to be performed, according to the techniques described herein. For example, as Bluetooth communications may be associated with relatively high bandwidth usage (e.g., >50%), device 110-d may determine the bandwidth for the Bluetooth communication exceeds a threshold (e.g., 50%), and may identify a rate of the encoding scheme associated with the Bluetooth communication. During the duration the WLAN procedure is to be performed, the device 110-d may reduce the rate of the encoding scheme for the Bluetooth communication, effectively reducing the bandwidth usage by Bluetooth communications. As such, WLAN procedures may be performed effectively (e.g., as there may be more unoccupied bandwidth available for the WLAN procedure due to the reduced rate of the encoding scheme used for Bluetooth). The Bluetooth communications may be associated with reduced quality during the WLAN procedure. However, due to the reduced Bluetooth bandwidth utilization, interruptions or glitches may be reduced as the Bluetooth communications at the reduced rate may not conflict with the WLAN procedure being performed.

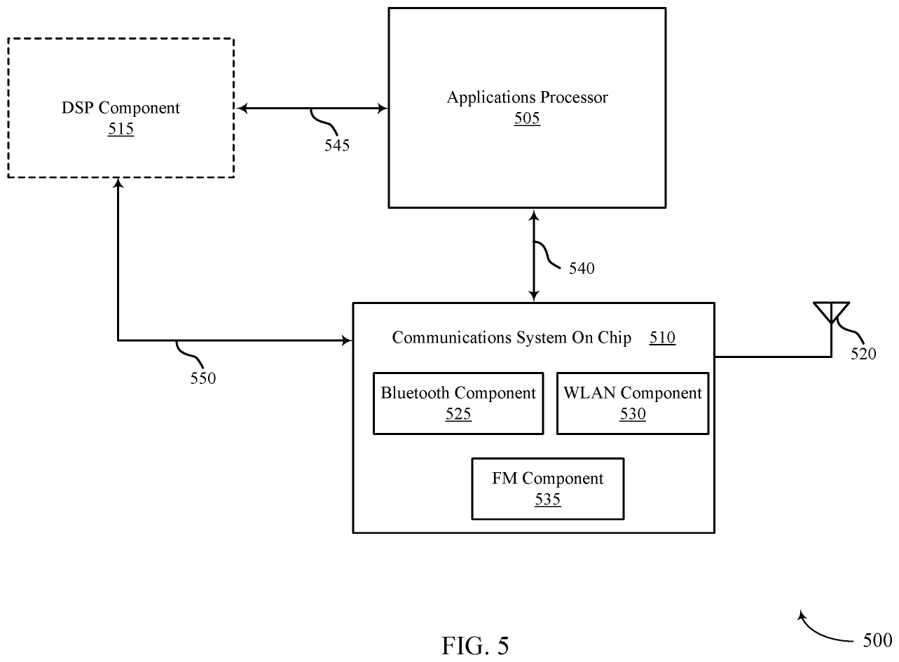

FIG. 5 illustrates an example block diagram 500 of a device that supports adaptive bit rates for Wi-Fi and Bluetooth coexistence in accordance with aspects of the present disclosure. In some examples, block diagram 500 may implement aspects of system 100. The device illustrated by block diagram 500 may include an applications processor 505, a communications system on chip (SoC) 510, a DSP component 515 and an antenna 520. Each of these components may be in communication with one another (e.g., via one or more buses or links, such as link 540, link 545, and link 550). In some cases, link 540, link 545, and link 550 may represent or refer to electrical connections between components where signals or information may be signaled, passed, or communicated amongst the components. In some cases, certain components or subcomponents may also be left out of, or combined in, the block diagram 500 (e.g., some operations described as being performed by separate components may be performed by a single component), or other components or subcomponents may be added to the block diagram 500 (e.g., some operations described as being performed by a single component may be performed by separate components).

An applications processor 505 may be or include an intelligent hardware device, (e.g., a general-purpose processor, a CPU, a microcontroller, an ASIC, an FPGA, a programmable logic device, a discrete gate or transistor logic component, a discrete hardware component, or any combination thereof). In some cases, applications processor 505 may be configured to execute computer-readable instructions stored in a memory to perform various functions (e.g., functions or tasks supporting applications, aspects of DSP, aspects of Bluetooth communication, aspects of WLAN communication). In some cases, applications processor 505 may refer to a host.

SoC 510 may include suitable logic, circuitry and/or code that may, for example, control or coordinate communications associated with different communication protocols. For example, SoC 510 may include Bluetooth component 525 (e.g., a Bluetooth chip), WLAN component 530, and FM component 535. In some cases, Bluetooth and WLAN in the 2.4 GHz industrial, scientific and medical (ISM) band may share the same unlicensed frequency medium. In some cases, the SoC 510 may coordinate Bluetooth component 525, WLAN component 530, and FM component 535 for avoiding interference in domains such as frequency, power, and time (e.g., as in some cases, Bluetooth component 525, WLAN component 530, and FM component 535 may share the same antenna 520). Frequency domain techniques may include adaptive frequency hopping (AFH), and power domain techniques may include power back-off or de-boosting. Time domain techniques may include some form of frame alignment.

DSP component 515 may include suitable logic, circuitry and/or code that may perform DSP. For example, DSP component may include an encoding block, a mapping block, a puncturing block, and an interleaving block, each of which may perform aspects of DSP operations performed by a device. Other configurations of a DSP component 515 are contemplated, without departing from the scope of the present disclosure (e.g., DSP component 515 may include additional subcomponents). Each subcomponent of DSP component 515 may include suitable logic, circuitry and/or code to perform their respective functions. In some cases, DSP component 515 (e.g., logic, circuitry and/or code that may perform DSP) may be included or implemented in applications processor 505 and/or SoC 510.

In some cases, the device may include a single antenna 520. However, in some cases the device may have more than one antenna 520, which may be capable of concurrently and/or simultaneously transmitting or receiving multiple wireless transmissions. In some examples, a device may include a transceiver that may communicate bi-directionally, via one or more antennas 520, wired, or wireless links as described herein. For example, a transceiver may represent a wireless transceiver and may communicate bi-directionally with another wireless transceiver (e.g., of a paired device). The transceiver may also include a modem to modulate the packets and provide the modulated packets to the antennas 520 for transmission, and to demodulate packets received from the antennas 520.

Some A2DP uses SBS codec. Despite the Bluetooth using A2DP SBC with other profiles, shared antenna conditions may be able to support both Bluetooth and WLAN functionalities with negligible impact on the quality of service (QoS) of either Bluetooth or WLAN. However, with the adoption of high bandwidth A2DP codecs from Bluetooth, shared antenna configurations of Bluetooth/WLAN may result in performance degradation of either Bluetooth (e.g., due to HD glitches or interruptions) or WLAN (e.g., due to interference during WLAN procedures). As such, the described techniques may provide for efficient use of higher bandwidth codecs for Bluetooth communications, as these higher bandwidth codecs may be temporarily reduced during WLAN procedures.

In some cases, the WLAN component 530 may identify a WLAN procedure and may request that the Bluetooth component 525 update the current Bluetooth medium usage. For example, the WLAN component 530 may expect a WLAN scanning procedure or a WLAN connection procedure and may send a request to Bluetooth component 525 for Bluetooth medium usage information. The Bluetooth component 525 may then indicate the current Bluetooth medium usage, taking into account all Bluetooth links, to the WLAN component 530. The WLAN component 530 may then request the Bluetooth component 525 reduce (e.g., or in some cases increase) the bit rate of A2DP.

For example, the WLAN component 530 may consider the Bluetooth medium usage indicated by Bluetooth component 525, as well as the Wi-Fi condition, to determine whether to decrease or increase the rate of the encoding scheme for Bluetooth communications. In some cases, if the WLAN condition is a WLAN procedure and the Bluetooth medium usage is undesirably high, the WLAN component 530 may request Bluetooth component 525 reduce the rate of the encoding scheme. In some cases, if the WLAN condition is a WLAN communication (e.g., regular WLAN traffic) and the Bluetooth medium usage is low, the WLAN component 530 may request Bluetooth component 525 increase the rate of the encoding scheme. As one example, an algorithm for the WLAN component 530 reducing the rate of the encoding scheme by 300 kbps for Bluetooth communications when the Bluetooth usage is greater than 70% may be as follows:

```
Do
{
  If (wlan_critical)
  {
  Request BW usage; Request codec/bit rate
  If (BW_Usage > 70%)
    Request to reduce by 300 kbps
    Update = 300;
  }
  Else
  {
  Request to increase by Update;
  Update = 0;
  }
}
While (1);
```

where the wlan_critical parameter may be set or triggered when a WLAN procedure is identified by the device (e.g., by the WLAN component of a device). The Request BW usage and Request codec/bit rate functions may refer to the WLAN component of the device signaling the request for the Bluetooth bandwidth and Bluetooth encoding scheme to the Bluetooth component of the device. The BW_Usage parameter may refer to the Bluetooth bandwidth usage indicated by the Bluetooth component (e.g., in response to the Request BW usage). In the example algorithm above, the Bluetooth bandwidth threshold may be set to a first value (e.g., 70%), such that when the Bluetooth bandwidth usage indicated by the Bluetooth component exceeds 70% (e.g., the BW_Usage >70%), the device may request the rate of the encoding scheme be reduced by, for example, 300 kbps. In the example algorithm above, if the Bluetooth bandwidth usage does not exceed the threshold, no changes to the encoding scheme may be made. However, in other examples, the rate of the encoding scheme may be increased when the Bluetooth bandwidth usage does not exceed the threshold (e.g., in the function: Else {Request to increase by Update; Update=0;}, the Update value may be set to some kbps constant, such that when the Bluetooth bandwidth usage does not exceed the threshold the rate of the encoding scheme may be increased by the Update constant).

As the Bluetooth component 525 and WLAN component 530 may be located on the same chip (e.g., the SoC 510), Bluetooth component 525 and WLAN component 530 may communicate according to some pre-defined communication protocol.

In some cases, information (e.g., data, audio) to be sent to a paired device (e.g., such as a Bluetooth headset) may be encoded at the DSP component 515 (e.g., at an encoding block). The encoded data may be signaled (e.g., passed or sent across) to Bluetooth component 525 via link 550, and the Bluetooth component 525 may transmit the encoded data to the paired device (e.g., via antenna 520). In some cases, the applications processor 505 may control aspects of the DSP component 515 (e.g., in some cases, some DSP related operations may be implemented at or controlled by applications processor 505, or applications processor 505 may control other aspects of DSP component 515). For example, in some cases, applications processor 505 may indicate an encoding scheme (e.g., an audio bit rate) to the DSP component 515 (e.g., via link 545), and the DSP component 515 may encode data according to the indicated encoding scheme.

As such, in some cases, the WLAN component 530 may be in communication with the applications processor 505 and/or DSP component 515 to reduce the rate of the encoding scheme for Bluetooth communication. Additionally or alternatively, Bluetooth component 525 may be in communication with the applications processor 505 and/or DSP component 515 to reduce the rate of the encoding scheme for Bluetooth communication.

For example, in some cases, after WLAN component 530 detects a WLAN procedure is to be performed, the WLAN component 530 may send the bit rate adjustment or the bit rate adjustment request to the applications processor 505 or the DSP component 515. Additionally or alternatively, after WLAN component 530 detects a WLAN procedure is to be performed, the WLAN component 530 may send the bit rate adjustment or the bit rate adjustment request to the Bluetooth component 525, and the Bluetooth component 525 may forward the bit rate adjustment or the bit rate adjustment request to the applications processor 505 or the DSP component 515.

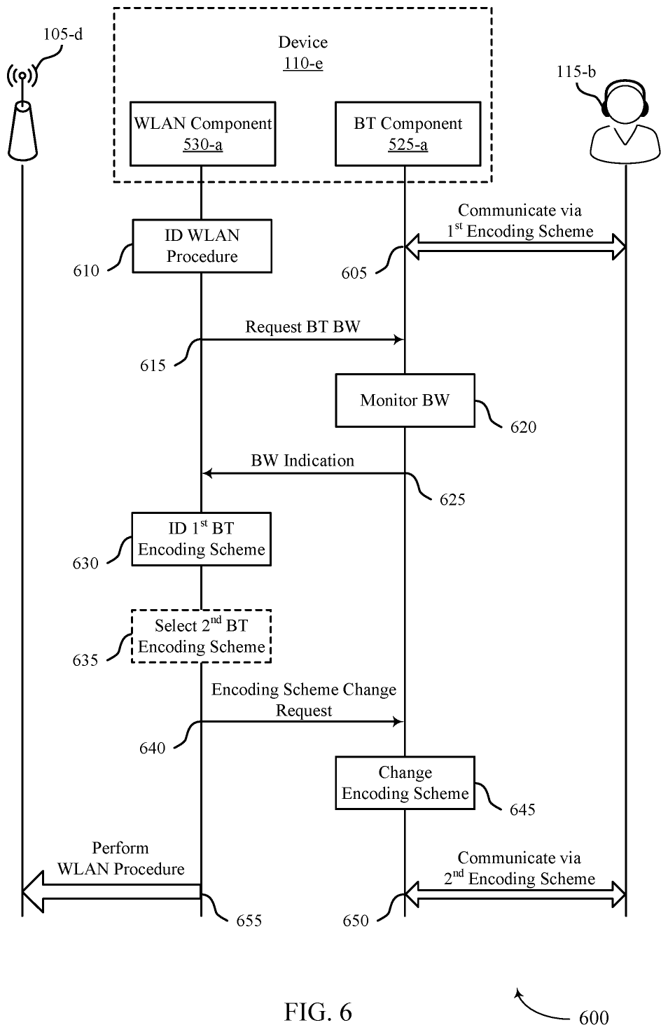

FIG. 6 illustrates an example of a process flow 600 that supports adaptive bit rates for Wi-Fi and Bluetooth coexistence in accordance with aspects of the present disclosure. In some examples, process flow 600 may implement aspects of system 100. Process flow 600 includes an AP 105-d, a device 110-e, and a paired device 115-b, which may be examples of an AP 105, device 110, and paired device 115 as described with reference to FIGS. 1-5. Process flow 600 may illustrate a device 110-e, which may include WLAN component 530-a and BT component 525-a, adjusting rates of encoding schemes (e.g., for Bluetooth communications with paired device 115-b) based on WLAN procedures to be performed (e.g., with AP 105-d). In the following description of the process flow 600, the passing of information between the WLAN component 530-a and the BT component 525-a may be performed in a different order than the exemplary order shown, or the operations performed by WLAN component 530-a and BT component 525-a may be performed in different orders, at different times, or in some cases, in conjunction with other components of the device 110-e (e.g., encoding schemes may be adjusted through or in conjunction with DSP component operation). In some cases, certain operations may also be left out of the process flow 600, or other operations may be added to the process flow 600.

At 605, BT component 525-a may communicate with paired device 115-b using a rate of a first encoding scheme (e.g., at 605, a first Bluetooth communication may be configured using the rate of the first encoding scheme).

At 610, WLAN component 530-a may identify a WLAN procedure to be performed. In some cases, the WLAN procedure may refer to a WLAN connection essential procedure, a critical WLAN functionality procedure, etc. For example, at 610, WLAN component 530-a may identify that a WLAN scanning procedure, a WLAN authentication and association procedure, a WLAN connection establishment procedure, a WLAN parameter negotiation procedure, etc. is to be performed (e.g., is to occur). In some cases, the WLAN procedure may be identified based on an identified pattern associated with the WLAN procedure. For example, device 110-e (e.g., WLAN component 530-a) may identify a pattern, periodicity, schedule, etc. associated with certain WLAN procedures, and may then identify WLAN procedures based on the pattern, periodicity, schedule, etc.

At 615, WLAN component 530-a may signal a request for BT component 525-a to signal the bandwidth for the first Bluetooth communication (e.g., the configured Bluetooth communication of 605).

At 620, BT component 525-a may monitor the bandwidth usage of the first Bluetooth communication or otherwise identify the bandwidth usage or the rate of the first encoding scheme used for the first Bluetooth communication.

At 625, BT component 525-a may signal an indication of the bandwidth for the first Bluetooth communication and/or the rate of the first encoding scheme associated with the first Bluetooth communication to WLAN component 530-a (e.g., based on the request received at 615). In some cases, the bandwidth usage (e.g., the Bluetooth bandwidth usage) may correspond to the bandwidth usage associated with the first Bluetooth communication. In some cases, the bandwidth usage (e.g., the Bluetooth bandwidth usage) may include determining a bandwidth associated with the first Bluetooth communication and one or more other Bluetooth communications (e.g., as Bluetooth communication may occur on more than one Bluetooth link). In such cases, the indication may include the total Bluetooth bandwidth usage (e.g., based on all Bluetooth communications of device 110-e).

At 630, WLAN component 530-a may identify the bandwidth usage and/or the rate of the first encoding scheme associated with the first Bluetooth communication based on the indication received at 625.

At 635, WLAN component 530-a may optionally select a rate of a second encoding scheme for a second (e.g., subsequent) Bluetooth communication based on the identified bandwidth usage and/or rate of the first encoding scheme. In some cases, WLAN component 530-a may determine that a throughput value associated with one or more WLAN communications exceeds a threshold, wherein the rate of the second encoding scheme for the second Bluetooth communication is selected based at least in part on the determination.

In some cases, the WLAN component 530-a may compare the determined Bluetooth bandwidth usage (e.g., identified at 630) to a threshold, and may select the rate of the second encoding scheme for the second Bluetooth communication is based at least in part on the comparison. In some cases, the rate of the second encoding scheme may be selected by another component of the device 110-e (e.g., by an applications processor of the device 110-e, by a DSP component of the device 110-e, by the BT component 525-a). In some cases, selecting the rate of the second encoding scheme for the second Bluetooth communication includes selecting a reduced bit rate for a first link associated with the first and second Bluetooth communication or selecting a reduced codec for the first link associated with the first and second Bluetooth communication.

At 640, WLAN component 530-a may signal a request for BT component 525-a to reduce the encoding scheme for the second Bluetooth communication (e.g., Bluetooth communication to occur during the WLAN procedure to be performed) based on the indication received at 625 and the WLAN procedure identified at 610. In cases where the WLAN component 530-a selects the rate of the second encoding scheme, the request may include the selected rate.

At 645, BT component 525-a may change or reduce the encoding scheme for the second Bluetooth communication based at least in part on the request received at 640. For example, in cases where the WLAN component 530-a selects the rate of the second encoding scheme, the request may include the selected rate and the BT component 525-a may implement the rate of the second encoding scheme. In cases where the BT component 525-a selects the rate of the second encoding scheme, the BT component 525-a may select the rate of the second encoding scheme (e.g., a reduced encoding scheme) based on the request and implement the rate of the second encoding scheme. In cases where a DSP component or other component of device 110-e selects the rate of the second encoding scheme, the BT component 525-a may work in conjunction with such a component to reduce the encoding scheme for the second Bluetooth communication based on the request.

At 650, BT component 525-a may communicate with paired device 115-b using the rate of the second encoding scheme (e.g., at 650, the second Bluetooth communication may be configured using the rate of the second encoding scheme).

At 655, WLAN component 530-a may perform the WLAN procedure (e.g., with AP 105-d) while the second Bluetooth communication is configured using the rate of the second encoding scheme. As discussed herein, the WLAN procedure may include a WLAN scanning procedure, a WLAN authentication and association procedure, a WLAN connection establishment procedure, a WLAN parameter negotiation procedure, or some combination thereof. In some cases, after the WLAN procedure has been completed, the WLAN component 530-a may indicate such to BT component 525-a, such that Bluetooth communications (e.g., a third Bluetooth communication occurring after the completed WLAN procedure) may be configured according to the original rate of the first encoding scheme.

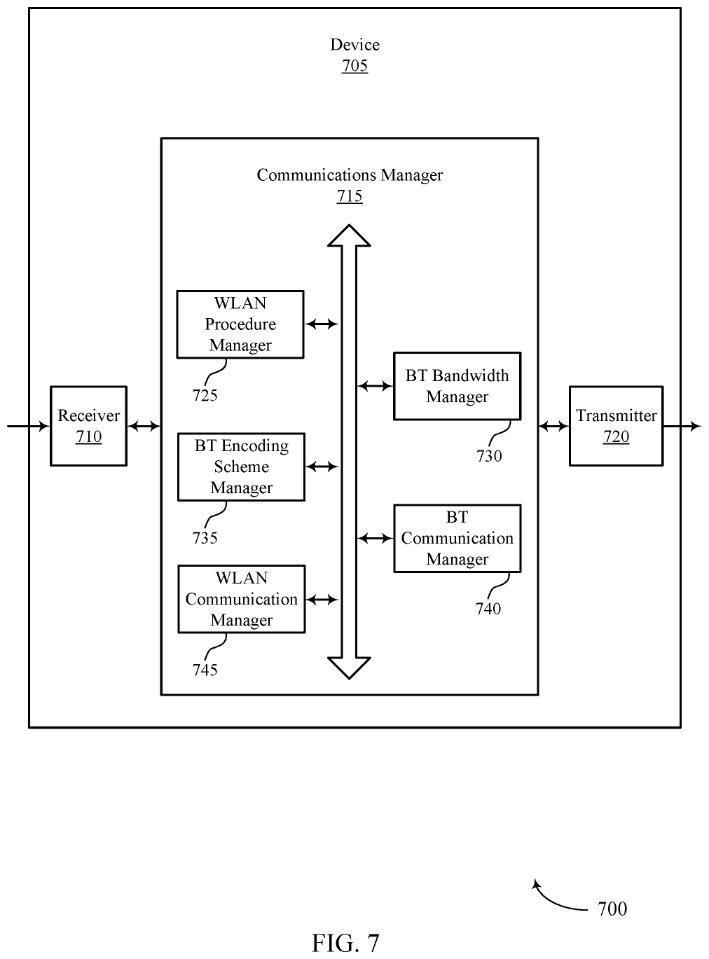

FIG. 7 shows a block diagram 700 of a device 705 that supports adaptive bit rates for Wi-Fi and Bluetooth coexistence in accordance with aspects of the present disclosure. The device 705 may be an example of aspects of a device 110 as described herein. The device 705 may include a receiver 710, a communications manager 715, and a transmitter 720. The device 705 may also include a processor. Each of these components may be in communication with one another (e.g., via one or more buses).

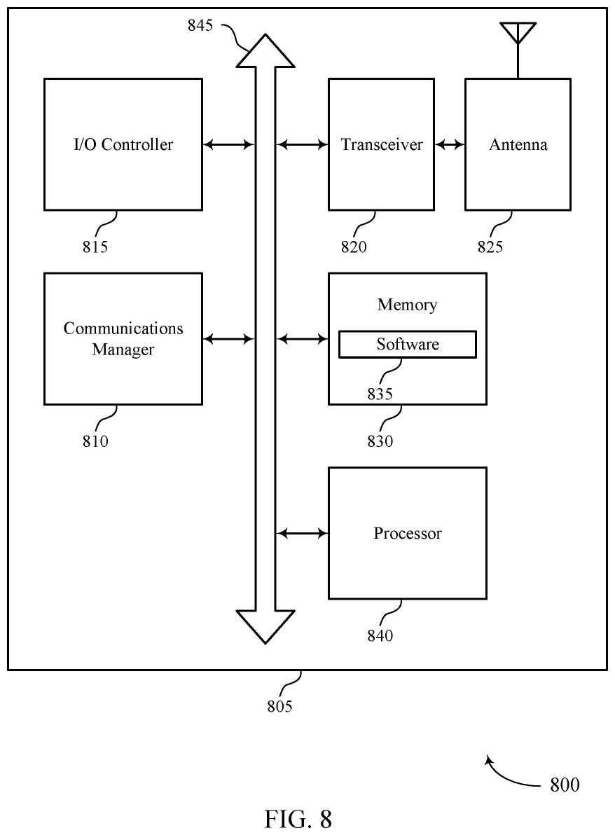

The receiver 710 may receive information such as packets, user data, or control information associated with various information channels (e.g., control channels, data channels, and information related to adaptive bit rates for Wi-Fi and Bluetooth coexistence). Information may be passed on to other components of the device 705. The receiver 710 may be an example of aspects of the transceiver 820 described with reference to FIG. 8. The receiver 710 may utilize a single antenna or a set of antennas.

The communications manager 715 may identify a WLAN procedure to be performed, perform the WLAN procedure while the second Bluetooth communication is configured using the rate of the second encoding scheme, determine a bandwidth for a first Bluetooth communication based on identifying the WLAN procedure to be performed, identify a rate of a first encoding scheme associated with the first Bluetooth communication based on the determined bandwidth, the rate of the first encoding scheme including a codec rate, or a bit rate, or both, and select a rate of a second encoding scheme for a second Bluetooth communication to be performed based on the identified WLAN procedure, the rate of the second encoding scheme being lower than the rate of the first encoding scheme. The communications manager 715 may be an example of aspects of the communications manager 810 described herein.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

For example, the communications manager 715 may include a WLAN procedure manager 725, a Bluetooth (BT) bandwidth manager 730, a BT encoding scheme manager 735, a BT communication manager 740, and a WLAN communication manager 745. Each of these components may communicate, directly or indirectly, with one another (e.g., via one or more buses). The communications manager 715 may be an example of aspects of the communications manager 810 described herein.

The WLAN procedure manager 725 may identify a WLAN procedure to be performed and perform the WLAN procedure while the second Bluetooth communication is configured using the rate of the second encoding scheme. In some examples, the WLAN procedure manager 725 may signal a request for a Bluetooth component of the device to reduce the encoding scheme associated with the second Bluetooth communication from the rate of the first encoding scheme to the rate of the second encoding scheme. In some examples, the WLAN procedure manager 725 may identify a pattern associated with the WLAN procedure, where the WLAN procedure to be performed is identified based on the pattern, and where signaling the request for the Bluetooth component of the device to reduce the encoding scheme for the second Bluetooth communication is based on the pattern.

In some examples, the WLAN procedure manager 725 may signal a request for the Bluetooth component of the device to signal the bandwidth for the first Bluetooth communication. In some examples, the WLAN procedure manager 725 may receive an indication of the bandwidth for the first Bluetooth communication based on the request, where the bandwidth for the first Bluetooth communication is determined based on the indication. In some examples, the WLAN procedure manager 725 may signal the request for the Bluetooth component of the device to reduce the encoding scheme for the second Bluetooth communication based on the indication of the bandwidth for the first Bluetooth communication. In some cases, the WLAN procedure includes a WLAN scanning procedure, a WLAN authentication and association procedure, a WLAN connection establishment procedure, a WLAN parameter negotiation procedure, or some combination thereof. In some examples, the WLAN procedure manager 725 may identify that the WLAN procedure has been performed.

The BT bandwidth manager 730 may determine a bandwidth for a first Bluetooth communication based on identifying the WLAN procedure to be performed (e.g., based on receiving a request from WLAN procedure manager 725). In some examples, the BT bandwidth manager 730 may compare the determined bandwidth for the first Bluetooth communication to a threshold, where selecting the rate of the second encoding scheme for the second Bluetooth communication is based on the comparison. In some examples, the BT bandwidth manager 730 may determine a bandwidth associated with at least one other Bluetooth communication (e.g., BT bandwidth manager 730 may take into account medium usage of all Bluetooth links), where identifying the rate of the first encoding scheme associated with the first Bluetooth communication is based on the determined bandwidth for the first Bluetooth communication and the determined bandwidth associated with the at least one other Bluetooth communication.

The BT encoding scheme manager 735 may identify a rate of a first encoding scheme associated with the first Bluetooth communication based on the determined bandwidth, the rate of the first encoding scheme including a codec rate, or a bit rate, or both. In some examples, the BT encoding scheme manager 735 may select a rate of a second encoding scheme for a second Bluetooth communication to be performed based on the identified WLAN procedure, the rate of the second encoding scheme being lower than the rate of the first encoding scheme.

In some examples, the BT encoding scheme manager 735 may select a rate of a third encoding scheme for a third Bluetooth communication to be performed based on the identification, the rate of the third encoding scheme being higher than the rate of the second encoding scheme. In some examples, the BT encoding scheme manager 735 may select a reduced bit rate for a first link associated with the first and second Bluetooth communication or select a reduced codec for the first link associated with the first and second Bluetooth communication. In some examples, the BT encoding scheme manager 735 may select a reduced codec for the first link associated with the first and second Bluetooth communication. In some cases, the rate of the third encoding scheme for the third Bluetooth communication includes the rate of the first encoding scheme associated with the first Bluetooth communication.

The BT communication manager 740 may perform the third Bluetooth communication based on the rate of the third encoding scheme. In some examples, the BT communication manager 740 may perform the second Bluetooth communication based on the rate of the first encoding scheme associated with the first Bluetooth communication and the identified WLAN communication.

The WLAN communication manager 745 may determine that a throughput value associated with one or more WLAN communications exceeds a threshold, where the rate of the second encoding scheme for the second Bluetooth communication is selected based on the determination. In some examples, the WLAN communication manager 745 may identify a WLAN communication to be performed.

The transmitter 720 may transmit signals generated by other components of the device 705. In some examples, the transmitter 720 may be collocated with a receiver 710 in a transceiver component. For example, the transmitter 720 may be an example of aspects of the transceiver 820 described with reference to FIG. 8. The transmitter 720 may utilize a single antenna or a set of antennas.

FIG. 8 shows a diagram of a system 800 including a device 805 that supports adaptive bit rates for Wi-Fi and Bluetooth coexistence in accordance with aspects of the present disclosure. The device 805 may be an example of or include the components of device 705 or a device 110 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may identify a WLAN procedure to be performed, perform the WLAN procedure while the second Bluetooth communication is configured using the rate of the second encoding scheme, determine a bandwidth for a first Bluetooth communication based on identifying the WLAN procedure to be performed, identify a rate of a first encoding scheme associated with the first Bluetooth communication based on the determined bandwidth, the rate of the first encoding scheme including a codec rate, or a bit rate, or both, and select a rate of a second encoding scheme for a second Bluetooth communication to be performed based on the identified WLAN procedure, the rate of the second encoding scheme being lower than the rate of the first encoding scheme.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described herein. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include RAM and ROM. The memory 830 may store computer-readable, computer-executable code or software 835 including instructions that, when executed, cause the processor to perform various functions described herein. In some cases, the memory 830 may contain, among other things, a BIOS which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting adaptive bit rates for Wi-Fi and Bluetooth coexistence).

The software 835 may include instructions to implement aspects of the present disclosure, including instructions to support wireless communications. The software 835 may be stored in a non-transitory computer-readable medium such as system memory or other type of memory. In some cases, the software 835 may not be directly executable by the processor 840 but may cause a computer (e.g., when compiled and executed) to perform functions described herein.

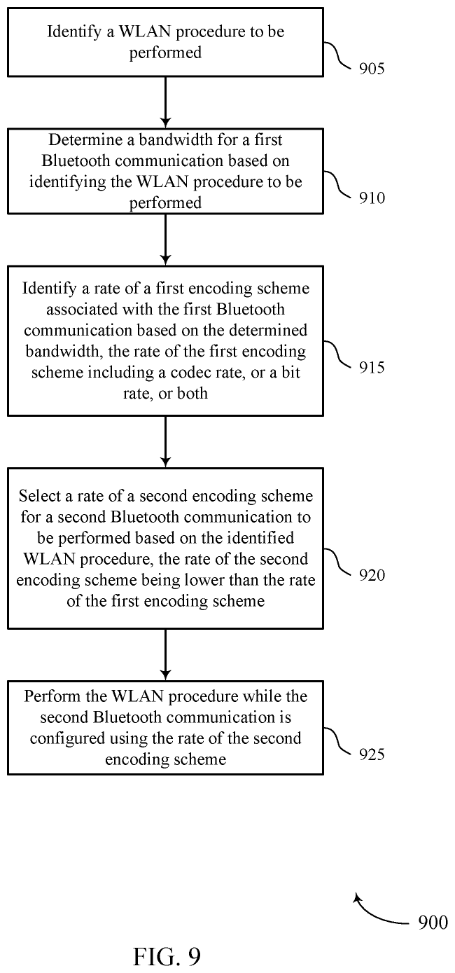

FIG. 9 shows a flowchart illustrating a method 900 that supports adaptive bit rates for Wi-Fi and Bluetooth coexistence in accordance with aspects of the present disclosure. The operations of method 900 may be implemented by a device or its components as described herein. For example, the operations of method 900 may be performed by a communications manager as described with reference to FIGS. 7 through 8. In some examples, a device may execute a set of instructions to control the functional elements of the device to perform the functions described herein. Additionally or alternatively, a device may perform aspects of the functions described herein using special-purpose hardware.

At 905, the device may identify a WLAN procedure to be performed. The operations of 905 may be performed according to the methods described herein. In some examples, aspects of the operations of 905 may be performed by a WLAN procedure manager as described with reference to FIGS. 7 through 8.

At 910, the device may determine a bandwidth for a first Bluetooth communication based on identifying the WLAN procedure to be performed. The operations of 910 may be performed according to the methods described herein. In some examples, aspects of the operations of 910 may be performed by a Bluetooth bandwidth manager as described with reference to FIGS. 7 through 8.

At 915, the device may identify a rate of a first encoding scheme associated with the first Bluetooth communication based on the determined bandwidth, the rate of the first encoding scheme including a codec rate, or a bit rate, or both. The operations of 915 may be performed according to the methods described herein. In some examples, aspects of the operations of 915 may be performed by a Bluetooth encoding scheme manager as described with reference to FIGS. 7 through 8.

At 920, the device may select a rate of a second encoding scheme for a second Bluetooth communication to be performed based on the identified WLAN procedure, the rate of the second encoding scheme being lower than the rate of the first encoding scheme. The operations of 920 may be performed according to the methods described herein. In some examples, aspects of the operations of 920 may be performed by a Bluetooth encoding scheme manager as described with reference to FIGS. 7 through 8.

At 925, the device may perform the WLAN procedure while the second Bluetooth communication is configured using the rate of the second encoding scheme. The operations of 925 may be performed according to the methods described herein. In some examples, aspects of the operations of 925 may be performed by a WLAN procedure manager as described with reference to FIGS. 7 through 8.

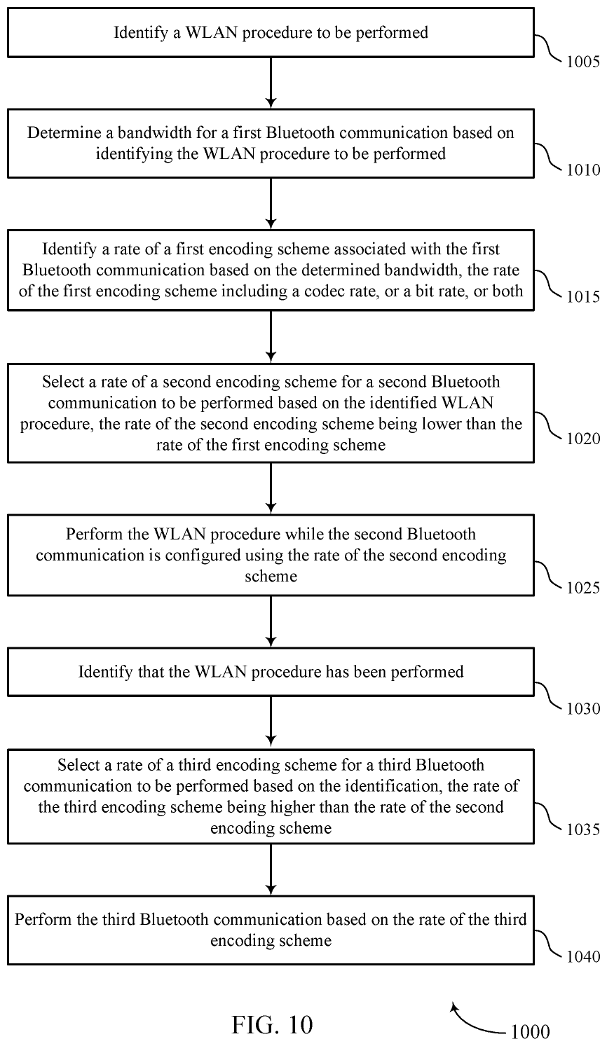

FIG. 10 shows a flowchart illustrating a method 1000 that supports adaptive bit rates for Wi-Fi and Bluetooth coexistence in accordance with aspects of the present disclosure. The operations of method 1000 may be implemented by a device or its components as described herein. For example, the operations of method 1000 may be performed by a communications manager as described with reference to FIGS. 7 through 8. In some examples, a device may execute a set of instructions to control the functional elements of the device to perform the functions described herein. Additionally or alternatively, a device may perform aspects of the functions described herein using special-purpose hardware.

At 1005, the device may identify a WLAN procedure to be performed. The operations of 1005 may be performed according to the methods described herein. In some examples, aspects of the operations of 1005 may be performed by a WLAN procedure manager as described with reference to FIGS. 7 through 8.

At 1010, the device may determine a bandwidth for a first Bluetooth communication based on identifying the WLAN procedure to be performed. The operations of 1010 may be performed according to the methods described herein. In some examples, aspects of the operations of 1010 may be performed by a Bluetooth bandwidth manager as described with reference to FIGS. 7 through 8.

At 1015, the device may identify a rate of a first encoding scheme associated with the first Bluetooth communication based on the determined bandwidth, the rate of the first encoding scheme including a codec rate, or a bit rate, or both. The operations of 1015 may be performed according to the methods described herein. In some examples, aspects of the operations of 1015 may be performed by a Bluetooth encoding scheme manager as described with reference to FIGS. 7 through 8.

At 1020, the device may select a rate of a second encoding scheme for a second Bluetooth communication to be performed based on the identified WLAN procedure, the rate of the second encoding scheme being lower than the rate of the first encoding scheme. The operations of 1020 may be performed according to the methods described herein. In some examples, aspects of the operations of 1020 may be performed by a Bluetooth encoding scheme manager as described with reference to FIGS. 7 through 8.

At 1025, the device may perform the WLAN procedure while the second Bluetooth communication is configured using the rate of the second encoding scheme. The operations of 1025 may be performed according to the methods described herein. In some examples, aspects of the operations of 1025 may be performed by a WLAN procedure manager as described with reference to FIGS. 7 through 8.

At 1030, the device may identify that the WLAN procedure has been performed. The operations of 1030 may be performed according to the methods described herein. In some examples, aspects of the operations of 1030 may be performed by a WLAN procedure manager as described with reference to FIGS. 7 through 8.

At 1035, the device may select a rate of a third encoding scheme for a third Bluetooth communication to be performed based on the identification, the rate of the third encoding scheme being higher than the rate of the second encoding scheme. The operations of 1035 may be performed according to the methods described herein. In some examples, aspects of the operations of 1035 may be performed by a Bluetooth encoding scheme manager as described with reference to FIGS. 7 through 8.

At 1040, the device may perform the third Bluetooth communication based on the rate of the third encoding scheme. The operations of 1040 may be performed according to the methods described herein. In some examples, aspects of the operations of 1040 may be performed by a Bluetooth communication manager as described with reference to FIGS. 7 through 8.

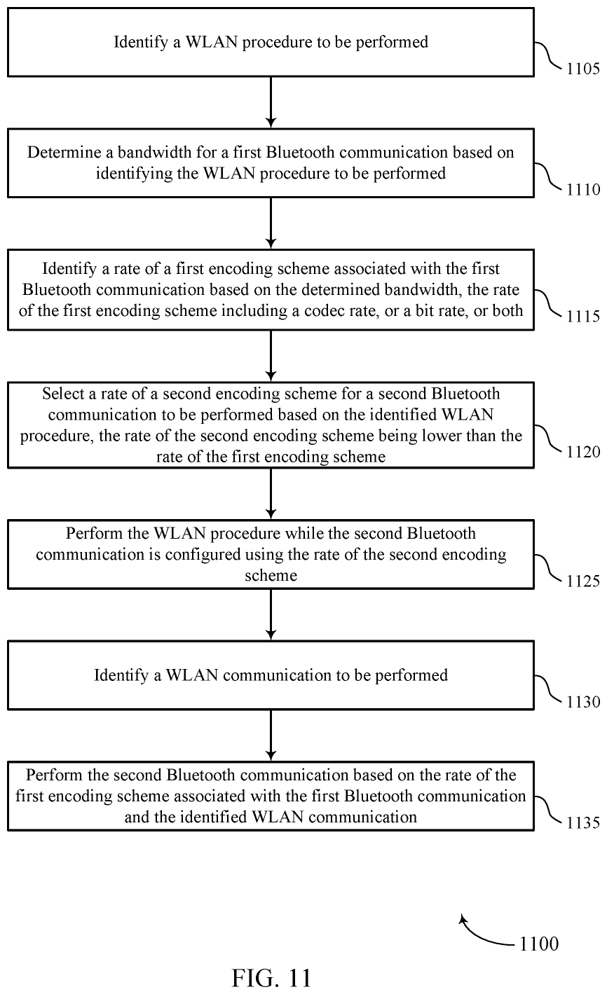

FIG. 11 shows a flowchart illustrating a method 1100 that supports adaptive bit rates for Wi-Fi and Bluetooth coexistence in accordance with aspects of the present disclosure. The operations of method 1100 may be implemented by a device or its components as described herein. For example, the operations of method 1100 may be performed by a communications manager as described with reference to FIGS. 7 through 8. In some examples, a device may execute a set of instructions to control the functional elements of the device to perform the functions described herein. Additionally or alternatively, a device may perform aspects of the functions described herein using special-purpose hardware.

At 1105, the device may identify a WLAN procedure to be performed. The operations of 1105 may be performed according to the methods described herein. In some examples, aspects of the operations of 1105 may be performed by a WLAN procedure manager as described with reference to FIGS. 7 through 8.

At 1110, the device may determine a bandwidth for a first Bluetooth communication based on identifying the WLAN procedure to be performed. The operations of 1110 may be performed according to the methods described herein. In some examples, aspects of the operations of 1110 may be performed by a Bluetooth bandwidth manager as described with reference to FIGS. 7 through 8.

At 1115, the device may identify a rate of a first encoding scheme associated with the first Bluetooth communication based on the determined bandwidth, the rate of the first encoding scheme including a codec rate, or a bit rate, or both. The operations of 1115 may be performed according to the methods described herein. In some examples, aspects of the operations of 1115 may be performed by a Bluetooth encoding scheme manager as described with reference to FIGS. 7 through 8.

At 1120, the device may select a rate of a second encoding scheme for a second Bluetooth communication to be performed based on the identified WLAN procedure, the rate of the second encoding scheme being lower than the rate of the first encoding scheme. The operations of 1120 may be performed according to the methods described herein. In some examples, aspects of the operations of 1120 may be performed by a Bluetooth encoding scheme manager as described with reference to FIGS. 7 through 8.

At 1125, the device may perform the WLAN procedure while the second Bluetooth communication is configured using the rate of the second encoding scheme. The operations of 1125 may be performed according to the methods described herein. In some examples, aspects of the operations of 1125 may be performed by a WLAN procedure manager as described with reference to FIGS. 7 through 8.

At 1130, the device may identify a WLAN communication to be performed. The operations of 1130 may be performed according to the methods described herein. In some examples, aspects of the operations of 1130 may be performed by a WLAN communication manager as described with reference to FIGS. 7 through 8.

At 1135, the device may perform the second Bluetooth communication based on the rate of the first encoding scheme associated with the first Bluetooth communication and the identified WLAN communication. The operations of 1135 may be performed according to the methods described herein. In some examples, aspects of the operations of 1135 may be performed by a Bluetooth communication manager as described with reference to FIGS. 7 through 8.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, system 100 FIG. 1—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a device, comprising:
identifying a wireless local area network (WLAN) procedure to be performed;
determining a bandwidth for a first Bluetooth communication based at least in part on identifying the WLAN procedure to be performed;
identifying a rate of a first encoding scheme associated with the first Bluetooth communication based at least in part on the determined bandwidth, the rate of the first encoding scheme comprising a codec rate, or a bit rate, or both;
selecting a rate of a second encoding scheme for a second Bluetooth communication to be performed based at least in part on the identified WLAN procedure, the rate of the second encoding scheme being lower than the rate of the first encoding scheme; and
performing the WLAN procedure while the second Bluetooth communication is configured using the rate of the second encoding scheme.

2. The method of claim 1, further comprising:
identifying that the WLAN procedure has been performed;
selecting a rate of a third encoding scheme for a third Bluetooth communication to be performed based at least in part on the identification, the rate of the third encoding scheme being higher than the rate of the second encoding scheme; and
performing the third Bluetooth communication based at least in part on the rate of the third encoding scheme.

3. The method of claim 2, wherein the rate of the third encoding scheme for the third Bluetooth communication comprises the rate of the first encoding scheme associated with the first Bluetooth communication.

4. The method of claim 1, wherein the WLAN procedure comprises a WLAN scanning procedure, a WLAN authentication and association procedure, a WLAN connection establishment procedure, a WLAN parameter negotiation procedure, or some combination thereof.

5. The method of claim 1, further comprising:
determining that a throughput value associated with one or more WLAN communications exceeds a threshold, wherein the rate of the second encoding scheme for the second Bluetooth communication is selected based at least in part on the determination.

6. The method of claim 1, further comprising:
identifying a WLAN communication to be performed; and
performing the second Bluetooth communication based at least in part on the rate of the first encoding scheme associated with the first Bluetooth communication and the identified WLAN communication.

7. The method of claim 1, further comprising:
signaling, using a WLAN component of the device, a request for a Bluetooth component of the device to reduce the encoding scheme associated with the second Bluetooth communication from the rate of the first encoding scheme to the rate of the second encoding scheme.

8. The method of claim 7, further comprising:
identifying, by the WLAN component of the device, a pattern associated with the WLAN procedure, wherein the WLAN procedure to be performed is identified based at least in part on the pattern, and wherein signaling the request for the Bluetooth component of the device to reduce the encoding scheme for the second Bluetooth communication is based at least in part on the pattern.

9. The method of claim 7, further comprising:
signaling, using the WLAN component of the device, a request for the Bluetooth component of the device to signal the bandwidth for the first Bluetooth communication;
receiving, using the WLAN component of the device, an indication of the bandwidth for the first Bluetooth communication based at least in part on the request, wherein the bandwidth for the first Bluetooth communication is determined based at least in part on the indication; and
signaling, using the WLAN component of the device, the request for the Bluetooth component of the device to reduce the encoding scheme for the second Bluetooth communication based at least in part on the indication of the bandwidth for the first Bluetooth communication.

10. The method of claim 1, further comprising:
comparing the determined bandwidth for the first Bluetooth communication to a threshold, wherein selecting the rate of the second encoding scheme for the second Bluetooth communication is based at least in part on the comparison.

11. The method of claim 1, wherein selecting the rate of the second encoding scheme for the second Bluetooth communication comprises:
selecting a reduced bit rate for a first link associated with the first and second Bluetooth communication; or; and
selecting a reduced codec for the first link associated with the first and second Bluetooth communication.

12. The method of claim 1, further comprising:
determining a bandwidth associated with at least one other Bluetooth communication, wherein identifying the rate of the first encoding scheme associated with the first Bluetooth communication is based at least in part on the determined bandwidth for the first Bluetooth communication and the determined bandwidth associated with the at least one other Bluetooth communication.

13. An apparatus for wireless communications at a device, comprising:
a processor,
memory in electronic communication with the processor; and
instructions stored in the memory and executable by the processor to cause the apparatus to:
identify a wireless local area network (WLAN) procedure to be performed;
determine a bandwidth for a first Bluetooth communication based at least in part on identifying the WLAN procedure to be performed;
identify a rate of a first encoding scheme associated with the first Bluetooth communication based at least in part on the determined bandwidth, the rate of the first encoding scheme comprising a codec rate, or a bit rate, or both;
select a rate of a second encoding scheme for a second Bluetooth communication to be performed based at least in part on the identified WLAN procedure, the rate of the second encoding scheme being lower than the rate of the first encoding scheme; and
perform the WLAN procedure while the second Bluetooth communication is configured using the rate of the second encoding scheme.

14. The apparatus of claim 13, wherein the instructions are further executable by the processor to cause the apparatus to:
identify that the WLAN procedure has been performed;
select a rate of a third encoding scheme for a third Bluetooth communication to be performed based at least in part on the identification, the rate of the third encoding scheme being higher than the rate of the second encoding scheme; and
perform the third Bluetooth communication based at least in part on the rate of the third encoding scheme.

15. The apparatus of claim 14, wherein the rate of the third encoding scheme for the third Bluetooth communication comprises the rate of the first encoding scheme associated with the first Bluetooth communication.

16. The apparatus of claim 13, wherein the WLAN procedure comprises a WLAN scanning procedure, a WLAN authentication and association procedure, a WLAN connection establishment procedure, a WLAN parameter negotiation procedure, or some combination thereof.

17. The apparatus of claim 13, wherein the instructions are further executable by the processor to cause the apparatus to:
determine that a throughput value associated with one or more WLAN communications exceeds a threshold, wherein the rate of the second encoding scheme for the second Bluetooth communication is selected based at least in part on the determination.

18. The apparatus of claim 13, wherein the instructions are further executable by the processor to cause the apparatus to:
identify a WLAN communication to be performed; and
perform the second Bluetooth communication based at least in part on the rate of the first encoding scheme associated with the first Bluetooth communication and the identified WLAN communication.

19. The apparatus of claim 13, wherein the instructions are further executable by the processor to cause the apparatus to:
signal, using a WLAN component of the device, a request for a Bluetooth component of the device to reduce the encoding scheme associated with the second Bluetooth communication from the rate of the first encoding scheme to the rate of the second encoding scheme.

20. An apparatus for wireless communications at a device, comprising:
means for identifying a wireless local area network (WLAN) procedure to be performed;
means for determining a bandwidth for a first Bluetooth communication based at least in part on identifying the WLAN procedure to be performed;
means for identifying a rate of a first encoding scheme associated with the first Bluetooth communication based at least in part on the determined bandwidth, the rate of the first encoding scheme comprising a codec rate, or a bit rate, or both;
means for selecting a rate of a second encoding scheme for a second Bluetooth communication to be performed based at least in part on the identified WLAN procedure, the rate of the second encoding scheme being lower than the rate of the first encoding scheme; and
means for performing the WLAN procedure while the second Bluetooth communication is configured using the rate of the second encoding scheme.
